(19) United States
(12) Patent Application Publication
(10) Pub. No.: US 2008/0155895 A1
(43) Pub. Date: Jul. 3, 2008

(54) Decorative coatings for plants and plant materials

(76) Inventors: Bobby Lewis Neal, Rock Hill, SC (US); Michael Sylvia, North Dartmouth, MA (US); Kumar Dighe, Charlotte, NC (US); Roger Weisberg, Kannapolis, NC (US); Wayne Rector, Rock Hill, SC (US)

Correspondence Address: FISH & RICHARDSON PC, P.O. BOX 1022, MINNEAPOLIS, MN, 55440-1022, US

(21) Appl. No.: 11/998,055

(22) Filed: Nov. 28, 2007

Related U.S. Application Data
(60) Provisional application No. 60/861,772, filed on Nov. 29, 2006.

(51) Int. Cl. A01G 13/00

(52) U.S. Cl. 47/57.7

(57) ABSTRACT

Decorated plants or plant materials include flowers, leaves and/or branches, and a decorative coating having a color, texture and/or gloss unusual to the native plant or plant material extending from a portion of a flower, leaf and/or branch. The coating is applied as a substantially anhydrous material. Methods are also described.

### CROSS-REFERENCE TO RELATED APPLICATION

This application claims priority from U.S. Provisional Patent Application Ser. No. 60/861,772, filed on Nov. 29, 2006, which is incorporated herein by reference in its entirety.

### TECHNICAL FIELD

This disclosure relates to decorative coatings for plants and plant materials, and to methods of making the same.

### BACKGROUND

Cut flowers and live plants can add color, drama and beauty to their surroundings. For these reasons, cut flowers and live plants are often used ceremonially, for example, at weddings, birthdays and anniversaries. The type of cut flower or live plant used to add color, drama or beauty can be synonymous with the season. For example, lilies are often used in the spring, pumpkins and gourds are often used in the fall, especially around Halloween, and live poinsettias are often used in the winter, especially during the holiday season.

### SUMMARY

Generally, decorated plants or plant materials are disclosed that include decorative coatings. Methods are also described.

In one aspect, the disclosure features decorated plants or plant materials that include a flower, leaf and/or branch, and a decorative coating having a color, texture and/or gloss unusual to the native plant or plant material extending from a portion of the flower, leaf and/or branch. The coating is applied as a substantially anhydrous material. For example, the substantially anhydrous material can include a solvent, a binder soluble and/or dispersible in the solvent and, optionally, a colorant, such as an insoluble, but dispersible pigment.

In another aspect, the disclosure features decorated plants or plant materials that include a flower, leaf and/or branch, and a decorative coating extending from a portion of the flower, leaf and/or branch. The decorative coating is applied as a substantially anhydrous material including a solvent, a binder soluble and/or dispersible in the solvent and, optionally, a colorant.

In some implementations, a measured pH of a 10 weight percent mixture of 92 parts by weight of the anhydrous material and 8 parts by weight of POE (4) lauryl alcohol in water is between about 5.5 and about 8.5, such as between about 6.0 and about 8.0 or between about 6.5 and bout 7.3. In some implementations, the pH of the 10 weight percent solution is substantially physiological.

In another aspect, the disclosure features methods of decorating plants or plant materials that include providing or selecting a plant or plant material; and applying a substantially anhydrous material that includes a solvent, a binder soluble and/or dispersible in the solvent and, optionally, a colorant to the plant or plant material to provide a coating on the plant or plant material.

Advantageously, the substantially anhydrous material is neither extremely basic nor is it extremely acidic. For example, in some implementations, a measured pH of a 10 weight percent mixture of 92 parts by weight of the anhydrous material and 8 parts by weight of POE (4) lauryl alcohol is between about 5.5 and about 8.5, such as between about 6.0 and about 8.0, or between about 6.5 and about 7.3. This property allows for live plants to be treated without substantially reducing their life span. This property also allows dried plant materials to be treated without harming the dried plant material.

In some desirable implementations, the colorant is or includes a substantially insoluble pigment, which is dispersible in the solvent. In such implementations, the insoluble pigments are neither extremely basic nor acidic.

In some implementations, the colorant is or includes a substantially insoluble pigment that is or includes mica and/or titanium dioxide.

In some advantageous implementations, the colorant is or includes a substantially insoluble pigment that has been ground to reduce its size. Such an implementation can improve color strength and brightness of the coating. For example, in some desirable implementations, the particles of the insoluble pigment have a maximum dimension of less than 5 μm, such as less than 2.5 μm, less than 1 μm, less than 0.5 μm, or even less than 0.25 μm.

The solvent can, e.g., be or include an alcohol, such as one or more of methanol, ethanol, n-propanol, isopropanol, n-butanol or isobutanol (2-methyl-1-propanol).

In desirable implementations, the alcohol comprises methanol and/or isobutanol.

The solvent can, e.g., also be or include an ether, such as ethyl ether and/or tetrahydrofuran.

Hydrocarbons can, e.g., also be used as solvent. For example, the hydrocarbon can be or can include heptane and/or toluene.

The solvent can, e.g., also be or include a ketone, such as acetone and/or methyl ethyl ketone, or an ester, such as ethyl acetate.

Advantageously, the solvent can have, e.g., a relatively low boiling point, allowing it to be easily removed from the coating. For example, the solvent can have a boiling point at 1 atm pressure of less than about 175° C., e.g., less than about 150° C., less than about 110° C., or even less than about 75° C. Advantageously, the solvent has a relatively high vapor pressure, allowing it to be easily removed. For example, the solvent can have a vapor pressure of greater than about 7.5 mm Hg at 25° C., e.g., greater than about 10, greater than about 25, greater than about 50, or greater than about 100 mm Hg at 25° C.

Lower molecular weight binders are generally preferable so as to maximize solubility in the solvent. For example, in some implementations, the binder has a number average molecular weight, relative to narrow disperse polyethylene glycol standards in tetrahydrofuran of less than about 25,000, e.g., less than about 20,000, 15,000, 10,000, 5,000, less than about 2,500, less than 1,500 or even less than 750.

In some desirable implementations, the binder is or includes a polyamide and/or a polyamide copolymer, such as a Nylon-6, Nylon-6,6, Nylon-10, Nylon-12, or a Nylon-6,12. In some particularly desirable implementations, the polyamide is or includes a Nylon-6 and/or a Nylon 6-based copolymer. To maximize solubility, it is often desirable that the polyamide have a relative viscosity (RV), as measured using ASTM D2857-95 in methanol, of less than about 50.0, such as less than about 40.0, 30.0, 20.0, 10.0, 7.5, 5.0, or less than about 2.5. In any of such implementations, the polyamide can have a relative viscosity of greater than 1.5 or 2.0.

In some implementations, the binder is present in the substantially anhydrous material from about 2.5 percent to about 30.0 percent by weight, e.g., from about 5.0 percent to about 27.5 percent or from about 7.0 percent to about 25.0 percent and/or the colorant (when present) is present in the substantially anhydrous material from about 7.5 percent to about 25 percent by weight, e.g., from about 10 percent to about 20 percent or from about 12.5 percent to about 18 percent and/or the solvent is present in the substantially anhydrous material from about 60.0 percent to about 95.0 percent by weight, e.g., from about 65.0 percent to about 90.0 percent or from about 70.0 percent to about 85.0 percent.

To prevent precipitation of the binder, it is often desirable that the substantially anhydrous material have less than about 1 percent by weight water, as measured by Karl Fischer titration using ASTM E203-01, e.g., less than about 0.5 percent, less than about 0.25 percent or even less than about 0.1 percent by weight water.

The substantially anhydrous material can, e.g., further include an anti-wicking material, an emulsifier, such as a non-ionic emulsifier and/or a biocidal material.

In some implementations, the provided or selected plant or plant material is a live plant, such as a potted plant or a tree. For example, live plant can be aloe, azalea, amaryllis, American ivy, bird-of-paradise, buttercup, cactus, day lily, Easter lily, hyacinth, hydrangea, ivy, jasmine, morning glory, oleander, poinsettia, and Virginia creeper.

In other implementations, the provided or selected plant or plant material is a non-living, dried plant material. For example, the non-living, dried plant material is selected from the group consisting of mosses, eucalyptus, cattails, bearded wheat, oak leaves, lotus pods, willow branches, palms, twisted ting ting, birch twigs, bamboo, pine cones, holly, sisal, wreathes, ferns, dried roses or mixtures of any of these.

In another aspect, the disclosure features methods of decorating plants or plant materials that include providing or selecting a plant or plant material; transferring the plant or plant material to an application station; applying a substantially anhydrous material that includes a solvent, a binder soluble in the solvent and, optionally, a colorant to the plant or plant material to provide a coating on the plant or plant material; and removing the solvent from the coating to provide a dried coating on the plant or plant material.

In some implementations, the solvent is removed by passing air over the plant or plant material having the coating. For example, in some implementations, the temperature of the air is not more than about 50° C., e.g., not more than about 35° C., not more than about 30° C. or not more than about 25° C. This can prevent harm to the plants or plant materials during their treatment.

Applying the coating can be, e.g., performed by dipping the plants or plant materials in a vessel containing the substantially anhydrous material, or by spraying the plants or plant materials with the substantially anhydrous material.

Implementations and/or aspects may include one or more of the following advantages. The coatings permit decoration of plants or plant materials with colors, gloss and/or texture that are unusual to the native plant or plant materials. The colors, gloss and/or textures can be exciting and can “wow” a viewer with enhanced “bling bling”. The colors are colorfast and generally do not run or wash off, for example, when the live plant is fed or watered. The coatings can be applied in a single step, often reducing time-consuming and costly multiple steps. The coatings can allow for unusual branding and marketing opportunities. For example, plants can be decorated according to the season or holiday. For example, plants can be painted orange and/or black during Halloween or can be painted with festive colors and/or textures that simulate snow and/or ice in the winter. The coatings can be applied to a variety of plants, including chrysanthemums, roses and poinsettias, without harming the plants. The coatings and the solutions in which they are applied are relatively non-toxic. The solutions in which the coatings are applied are sprayed using standard paint spraying guns and compressed air. Relative to some water-based coating systems, colors can be brighter. Many of the coatings do not substantially reduce the life span of live plants. Many of the coatings do not adversely effect dried plant materials. The coating systems are substantially anhydrous. The coatings “dry” and/or cure rapidly. The coatings are uniform in thickness. The coatings can be dried using room in low temperature air, e.g., less than 35° C. Many of the coating materials are neither appreciably acid nor appreciably basic. Many of the coatings do not require the addition of bases or acid, such as acetic acid, to dissolve or disperse the colorants.

A “substantially anhydrous material” is one that has less than about 2.5 weight percent water, preferably less than 1 weight percent, as measured by Karl Fischer titration using ASTM E203-01.

Unless otherwise defined, all technical and scientific terms used herein have the same meaning as commonly understood by one of ordinary skill in the art to which this invention belongs. Although methods and materials similar or equivalent to those described herein can be used, suitable methods and materials are described below. All publications, patent applications, patents, and other references mentioned herein are incorporated by reference herein in their entirety for all that they each contain. In case of conflict, the present specification, including definitions, will control. In addition, the materials, methods, and examples are illustrative only and not intended to be limiting. Other features and advantages will be apparent from the following detailed description, and from the claims.

### DESCRIPTION OF DRAWINGS

FIG. 1 is a color photograph taken from above a live poinsettia having a red-colored coating applied to its leaves.

FIG. 1′ is a black and white rendering of the photograph of FIG. 1.

FIG. 1A is an enlarged photograph of the poinsettia of FIG. 1.

FIG. 1A′ is a black and white rendering of the photograph of FIG. 1A.

FIG. 2 is a color photograph taken from the side of a sprayer suitable for applying the coating shown in FIGS. 1 and 1A.

FIG. 2′ is a black and white rendering of the photograph of FIG. 2.

FIG. 2A is a color photograph of a compressor suitable for driving the sprayer of FIG. 2.

FIG. 2A′ is a black and white rendering of the photograph of FIG. 2A.

FIG. 3 is a schematic representation of a process used to dip-coat dried plant materials.

FIG. 4 is a color photograph taken from above a live poinsettia having a gold-colored coating applied to its leaves.

FIG. 4′ is a black and white rendering of the photograph of FIG. 4.

FIG. 5 is a color photograph taken from above a live poinsettia having a lavender-colored coating applied to its leaves.

FIG. 5′ is a black and white rendering of the photograph of FIG. 5.

FIGS. 6 and 7 are color photographs of various dried plant materials having a coating applied thereto, while FIGS. 6′ and 7′ are black and renderings of FIGS. 6 and 7.

### DETAILED DESCRIPTION

Organic solvent-based coating systems are disclosed that are useful for the coloration of plants, e.g., live potted plants having leaves and/or flowers, and plant materials, such as dried flowers or grasses. The coatings can provide color, gloss and/or texture unusual to the native plant or plant material without harming the plant or reducing its life span.

Generally, decorated plants are provided that include a decorative coating extending from a portion of the plant or plant material. The decorative coating is applied as a substantially anhydrous material that includes a solvent, a binder soluble and/or dispersible in the solvent and, optionally, a colorant. Applying the coating as a substantially anhydrous material can be advantageous for at least the following reasons. First, such coatings can “dry” faster, which can increase productivity. Second, such coatings allow substantially water-insoluble binders to be utilized, which can provide coatings having enhanced color fastness with a reduced tendency to be washed off, e.g., when the plant or plant material becomes wet (e.g., during watering of a live plant).

In advantageous implementations, the substantially anhydrous material is not appreciably acidic or basic. For example, a measured pH of a 10 weight percent mixture of 92 parts by weight of the anhydrous material and 8 parts by weight of POE (4) lauryl alcohol in water can be between about 5.5 and about 8.5, e.g., between about 6.0 and about 8.0 or between about 6.5 and about 7.3. In some implementations, the pH is at or about physiological pH. Having a material that is not appreciably acidic or basic in nature assures that the coatings will not substantially reduce the life span of a live plant, or adversely effect dried plant materials. To measure, 92 parts by weight of the anhydrous material and 8 parts by weight of POE (4) lauryl alcohol are combined to provide an emulsified material, and then 10 parts by weight of this emulsified mixture is added to 90 parts by weight water. The pH of this combined material is then measured.

Application of the substantially anhydrous material without a colorant can provide gloss and/or texture unusual to the native plant or plant material. In combination with the colorant, the substantially anhydrous material can provide beautiful, often powerful, coloration, gloss and/or texture to the plant or plant materials. For example, a glossy coating can be provided or a matt surface can be provided (with or without color).

In desirable implementations, the colorant is or includes a substantially insoluble pigment which is dispersible in the solvent. Such colorants generally do not require the addition of acids or bases to provide dissolution and can also provide brighter coatings relative to solution soluble pigment, such as an acidic or basic dye. Without wishing to be bound by any particular theory, it is believed that brighter coatings arise because the insoluble pigments tend to lay down on outer surfaces, rather than being encapsulated and hidden inside of binders. This property can also make the product and process less expensive because less colorant needs to be used to obtain a desired effect.

When the colorant is or includes a substantially insoluble pigment, the pigment can include mica and/or titanium dioxide. The pigment can be or can include a fluorescent, pearlescent, metallic and/or metal-simulating pigment.

While pigments are generally most desirable, in some implementations, the colorant is or includes a dye (e.g., an acid dye), such as a fluorescent or a non-fluorescent dye.

Desirably, when the colorant is or includes a substantially insoluble pigment which is dispersible in the solvent, the pigment is or includes particles which have been ground to reduce their size. For example, the particles can have a maximum dimension of less than about 5 μm, e.g., less than about 2.5 μm, less than about 1 μm, less than about 0.5 μm, or even less than about 0.25 μm. Particle size reduction can, e.g., increase color brightness and color uniformity and can also reduce the amount of pigment needed to provide a desired effect.

In desirable implementations, the solvent is or includes is an alcohol, such as methanol, ethanol, n-propanol, isopropanol, n-butanol, isobutanol (2-methyl-1-propanol) or mixtures of one or more of these alcohols. In some implementations, the alcohol is or includes methanol and/or isobutanol. In particularly desirable implementations, the alcohol is a relatively non-toxic alcohol, such as ethanol, propanol, isopropanol or isobutanol.

In some implementations, the solvent is or includes an ether. For example, the ether can be a non-cyclic ether (e.g., ethyl ether) and/or a cyclic ether, e.g., tetrahydrofuran. Particularly desirable ethers are those which are relatively non-toxic, such as ethyl ether.

In some implementations, the solvent is or includes a hydrocarbon, such as heptane and/or toluene. Hydrocarbon solvents can be desirable because they can be easy to dry of and some have a relatively low toxicity.

In other implementations, the solvent is or includes a ketone, such as acetone and/or methyl ethyl ketone. In still other implementations, the solvent is or includes an ester, such as ethyl acetate.

Regardless of the chemical constitution of the solvent, in desirable implementations, the solvent has a boiling point at 1 atm pressure of less than about 175° C., e.g., less than about 150° C., less than about 110° C., or less than about 75° C. A relatively low boiling point allows the applied coating to dry and set-up and/or cure in a relatively short amount of time.

Regardless of the chemical constitution of the solvent, in desirable implementations, the solvent has a vapor pressure of greater than about 7.5 mm Hg at 25° C., such as greater than about 10, greater than about 25, greater than about 50, or greater than about 100 mm Hg at 25° C. A high vapor pressure also generally allows the applied coating to dry and set-up and/or cure in a relatively short amount of time.

Examples of soluble and/or dispersible binders include polyesters (or polyester copolymers), polyamides (or polyamide copolymers), acrylic resins, styrene-acrylic resins, vinyl-acrylic resins, polyvinyl acetate-based resins or polyurethanes.

In desirable implementations, the binder is or includes a soluble and/or dispersible polyamide and/or a polyamide copolymer, such as a Nylon-6, Nylon-6,6, Nylon-10, Nylon-12, or a Nylon-6,12. In other implementations, the binder is or includes mixtures of any one of the mentioned polyamides or polyamide copolymers. In advantageous implementations, the polyamide is or includes a Nylon-6 and/or a Nylon 6-based copolymer. It is desirable that the polyamide or polyamide copolymer have a relatively low molecular weight. For example, the polyamide or polyamide copolymer or mixture thereof can have a relative viscosity (RV), as measured using ASTM D2857-95 in methanol, of less than about 50.0, e.g., less than about 40.0, 30.0, 20.0, 10.0, 7.5, 5.0, or less than about 2.5. In any of such implementations, the RV can be greater than 1.25, 1.5, 1.75 or greater than 2.0.

It is often advantageous that the binder be or include a crosslinker. In such implementations, the crosslinker can provide durability and/or colorfastness to the coating, preventing color leaching and/or migration of color, e.g., when the plant is watered, or when the plant is placed in a moist or humid environment.

In some implementations, the binder is or includes a crosslinker that cures under ambient conditions. Ambient conditions can include, e.g., a temperature of from about 55° F. (12.8° C.) to about 105° F. (40.6° C.), or from about 60° F. (15.6° C.) to about 95° F. (35.0° C.). In addition, ambient conditions can also include relative humidity between about 25 percent and about 98 percent, e.g., between about 40 percent and about 95 percent.

Examples of crosslinkers include acrylic resins, styrene-acrylic resins, vinyl-acrylic resins, polyvinyl acetate-based resins, polyurethanes, polymers having unreacted isocyanate groups, alkoxysilanes, polycarbodiimides, nitrile latexes, SBR resins, activated vinyl polymers, such as vinyl ethers, vinyl carbonates and vinyl carbamates. Preferred crosslinkers are self-crosslinking, meaning that they do not require a catalyst, such as an acid, base or metal, to initiate the crosslinking process. An example of an ambient cure crosslinker is the vinyl-acrylic copolymer Paranol® VA 903, a self-crosslinking material, having a low glass transition temperature. Paranol® VA 903 is available from Para-Chem Southern, Inc. of Simpsonville, S.C. Other examples of ambient cure crosslinkers are polycarbodiimides, such as those described in Watson, U.S. Pat. No. 4,977,219.

The binder can also be or include a polymeric material having a glass transition temperature of less than about 50° F. (10.0° C.), e.g., less than about 25° F. (−3.9° C.), less than about 0° F. (−17.8° C.), less than about −20° F. (−28.9° C.), or even less than −45° F. (−42.8° C.). Having a low glass transition temperature material in the formulation provides an adhesive coating on the plant or plant material that is, at least initially, tacky or sticky to the touch. Such a coating allows for application of secondary color and/or texture substances, such as glitter or artificial snow. The low glass transition temperature material can be a crosslinker.

Examples of low glass transition temperature materials include acrylic resins, styrene-acrylic resins, vinyl-acrylic resins, polyvinyl acetate-based resins, polyurethanes, nitrile latexes, SBR resins, poly(vinyl ethers), poly(vinyl carbonates), poly(vinyl carbamates), polyolefins, polyesters and polyamides. An example of a low glass transition temperature polymeric material is the styrene-acrylic latex material Paranol® JRB-AU-40, which is available from Para-Chem Southern, Inc. of Simpsonville, S.C. Paranol® VA 903 (discussed above) is an example of a low glass transition temperature crosslinking material.

Regardless of its chemical constitution, it is often desirable that the binder have a relatively low molecular weight. A relatively low molecular weight typically insures that the binder will be soluble in an anhydrous solvent and that solutions that include such binders are generally not overly viscous. For example, the binder can have a number average molecular weight relative to narrow disperse polyethylene glycol standards in tetrahydrofuran, of less than about 25,000, e.g., less than about 20,000, 15,000, 10,000, 5,000, less than about 2,500, less than about 1,500 or less than about 750.

Regardless of its chemical constitution, it is often desirable that the binder be present in the anhydrous material of from about 2.5 percent to about 30.0 percent by weight, e.g., such as from about 5.0 percent to about 27.5 percent or from about 7.0 percent to about 25.0 percent. Maintaining a relatively low amount of binder in the coating material ensures that the coating material is not overly viscous and tends to minimize the cost of the coating material.

In some implementations, the colorant is present in the substantially anhydrous material from about 7.5 percent to about 25 percent by weight, e.g., from about 10 percent to about 20 percent or from about 12.5 percent to about 18 percent and the solvent is present in the substantially anhydrous material from about 60.0 percent to about 95.0 percent by weight, e.g., from about 65.0 percent to about 90.0 percent or from about 70.0 percent to about 85.0 percent.

In desirable implementations, e.g., so that the binder does not precipitate from solution, the substantially anhydrous material has less than about 1 percent by weight water, as measured by Karl Fischer titration using ASTM E203-01, e.g., less than 0.5 percent, less than 0.25 percent or even less than about 0.1 percent by weight water.

The substantially anhydrous material can further includes an anti-wicking material, which can provide colorfastness to the coating prior to set up, resisting color leaching and/or migration of color. Examples of anti-wicking materials include polyesters, such as carboxylated polyesters, polyamides, acrylics, such as poly(acrylic acid), natural gums, such as guar and locust bean gum, starches and alginates. Specific examples anti-wicking materials include Polytech PT 630, a carboxylated polyester available from PolyTech, Inc. (PTI) of Greer, S.C. or Superclear 320N, a poly(acrylic acid)-based liquid binding aid available from Cognis Corporation, Cincinnati, Ohio.

The substantially anhydrous material can also further include an emulsifier. Generally, emulsifier helps in dispersing pigments and/or dyes in the formulations, and can also aid in compatibilizing disparate materials, such as hydrophobic and hydrophilic materials. In desirable implementations, non-ionic emulsifiers are utilized since they do not typically change the pH of the substantially anhydrous material when mixed with water. Examples of non-ionic emulsifiers and wetting agents include: PEG-20 glyceryl stearate, stearic acid, palmitic acid, PEG-7 hydrogenated castor oil, polyglyceryl-2, dipolyhydroxystearate, ceteareth-12, ceteareth-20, ceteareth-30, PEG-60 hydrogenated castor oil, oleth-30, polyethylene glycol monostearate, and cetearyl alcohol. Still other non-ionic emulsifiers and wetting agents include secondary alcohol ethoxylates, octylphenol ethoxylates and nonylphenol ethoxylates. Suitable emulsifiers and wetting agents are available from Cognis Corporation and Dow Chemical, e.g., under the tradenames TRITON™ and TERGITOL™. Still others are available from Ethox Chemicals, LLC (Greenville, S.C.) and Rhodia. In specific implementations, POE (4) lauryl alcohol is utilized, which is lauryl alcohol with 4 moles of ethylene oxide, commonly called LA4. LA4 is available, e.g., from Ethox, under the tradename ETHAL LA-4 or Rhodia under the tradename RHODSURF LA4.

Any formulation described herein can include one or more biocidal materials to prevent fungal and bacterial overgrowth in the formulations. Biocides include, e.g., mixtures of benzylated chlorophenols (Nipacide 10), ortho-benzyl-para-chlorophenol (Nipacide BCP or Chlorophen) and mixture of chlorinated xylenols (Nipacide CX 140). Suitable biocides are available from Clariant and Aspen Solutions.

In some implementations, the substantially anhydrous material is applied to a live plant, such as a potted plant or a tree. Examples of live plants include aloe, azalea, amaryllis, American ivy, bird-of-paradise, buttercup, cactus, day lily, Easter lily, hyacinth, hydrangea, ivy, jasmine, morning glory, oleander, poinsettia and Virginia creeper.

In other implementations, the plant or plant material is a non-living, dried plant material. Examples of non-living, dried plant materials are mosses, eucalyptus, cattails, bearded wheat, oak leaves, lotus pods, willow branches, palms, twisted ting ting, birch twigs, bamboo, pine cones, holly, sisal, wreathes, ferns, dried roses or mixtures of any of these.

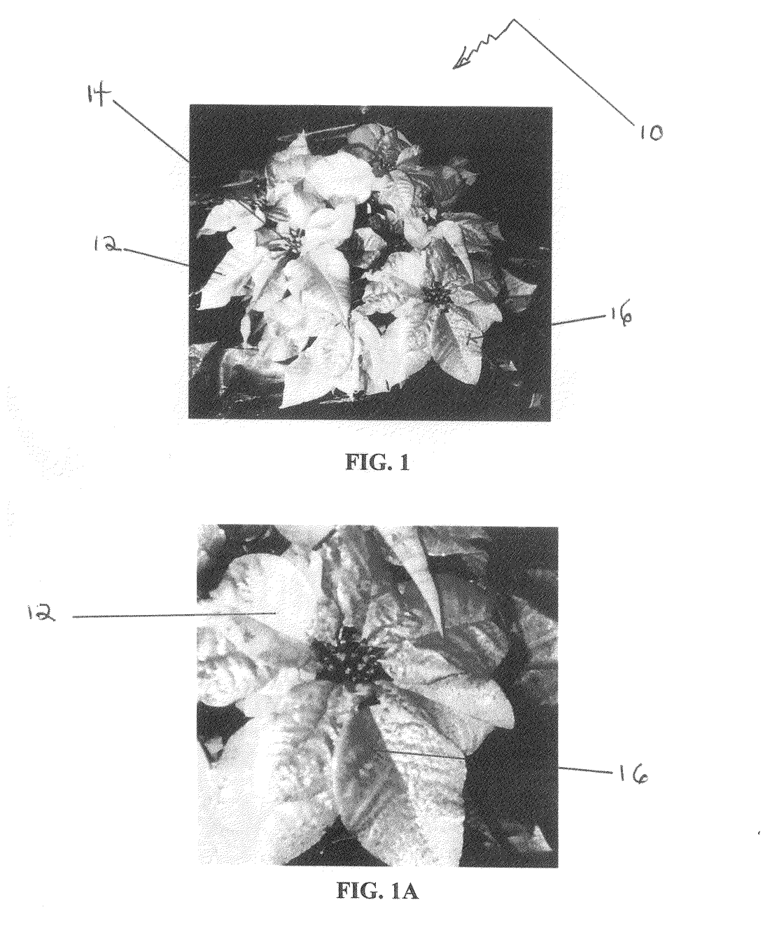

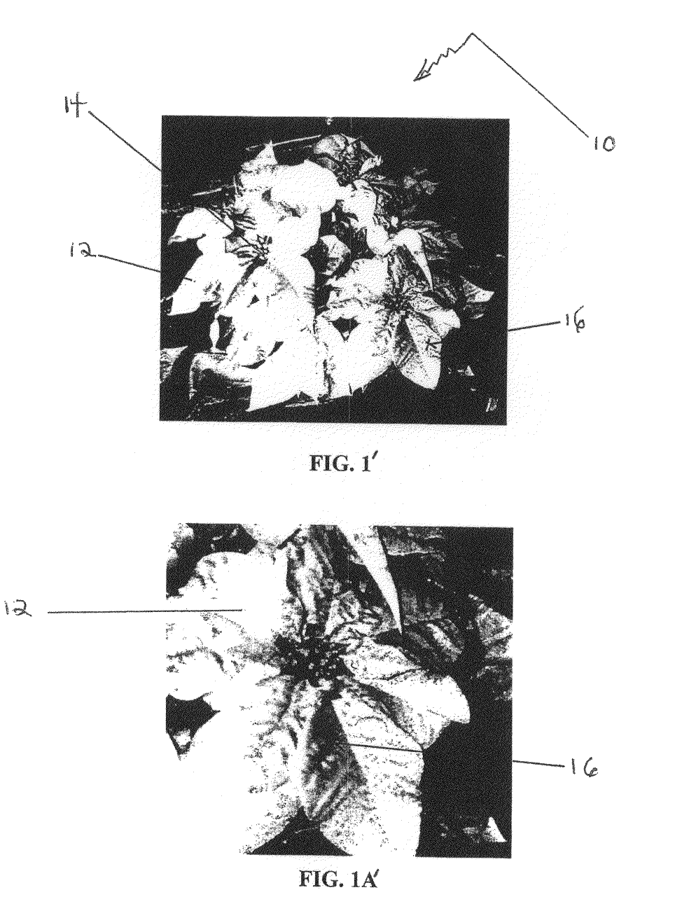

As an example, and by reference to FIGS. 1 and 1A, a decorated poinsettia 10 has pale yellow leaves 12 and flowers 14 that have a vibrant, red-colored coating 16 extending therefrom. The particular coating shown was applied as a substantially anhydrous material that included a 9:1 (v/v) mixture of methanol:isobutanol as solvent, a Nylon-6-based binder and a red pigment that was dispersible in, but not soluble in, the solvent.

Generally, the decorated plants or plant materials are made by providing or selecting the desired plant or the plant material, and then applying the substantially anhydrous material to the plant or plant material. For example, the formulations can be sprayed onto the plant or plant material using a commercial compressed air sprayer. Alternatively, the plant or plant material can be dip coated. When spraying, it is desirable that the formulation have a working pot life long enough to allow for application of the formulation and clean up of the application device, e.g., sprayer.

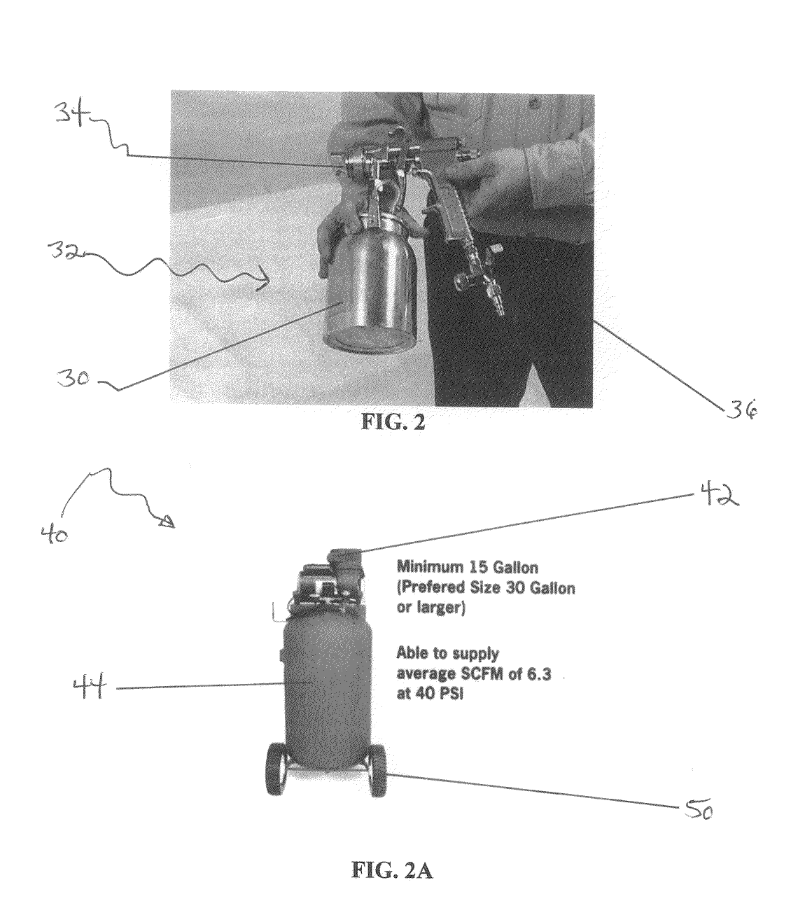

As an example, and by reference to FIGS. 2 and 2A, the decorated poinsettia 10 of FIGS. 1 and 1A can be made by adding the red formulation to the liquids container 30 of a spray gun 32 having a nozzle 34 through which the formulation is ejected, a pressure gauge 36 for adjusting and monitoring ejection pressure, and a coupler to connect the spray gun to the compressor system 40 (FIG. 2A). The compressor system 40 includes an electric motor 42 for compressing the air and a compressed air chamber 44 for containing the compressed air. Because of its weight, it is desirable that the compressor system 40 also include a set of wheels 50 for moving the compressor system 40 to a desired spraying location. Generally, any commercial sprayer driven by a 15-30 gallon air compressor, that can deliver at least 6.3 standard cubic feet per minute (SCFM) of air at 40 PSI is suitable for the spraying the formulations. In embodiments in which a Pro Value Model #2308-PV sprayer is used, which is available from Advance Auto Parts, it is desirable to use a pressure setting of from about 18-22 PSI, since settings above 22 PSI can permanently distort the plant or plant material.

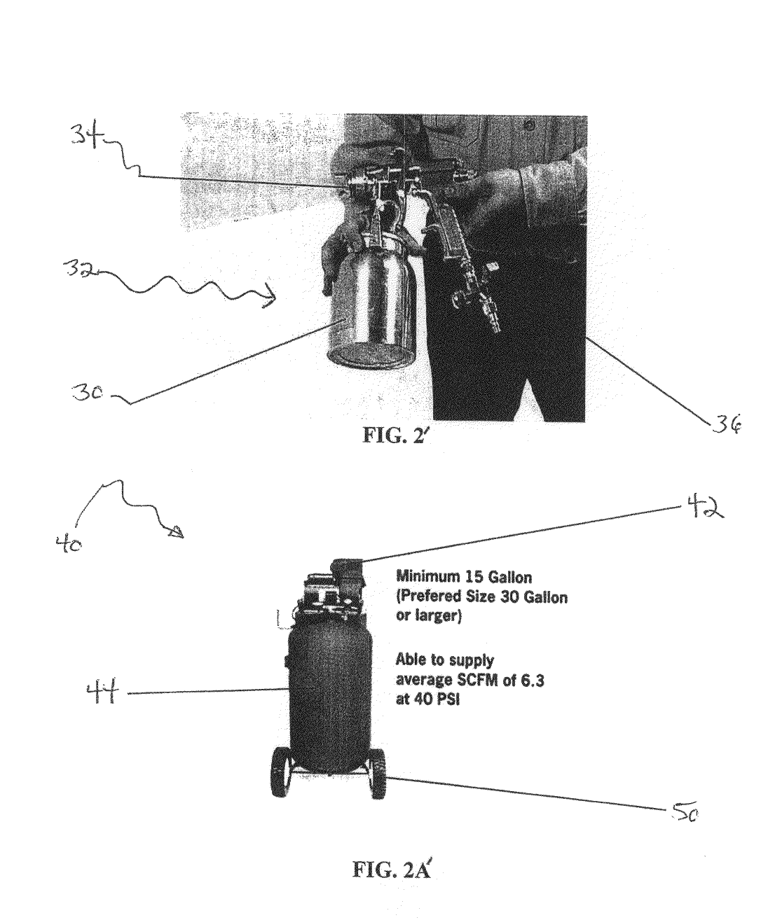

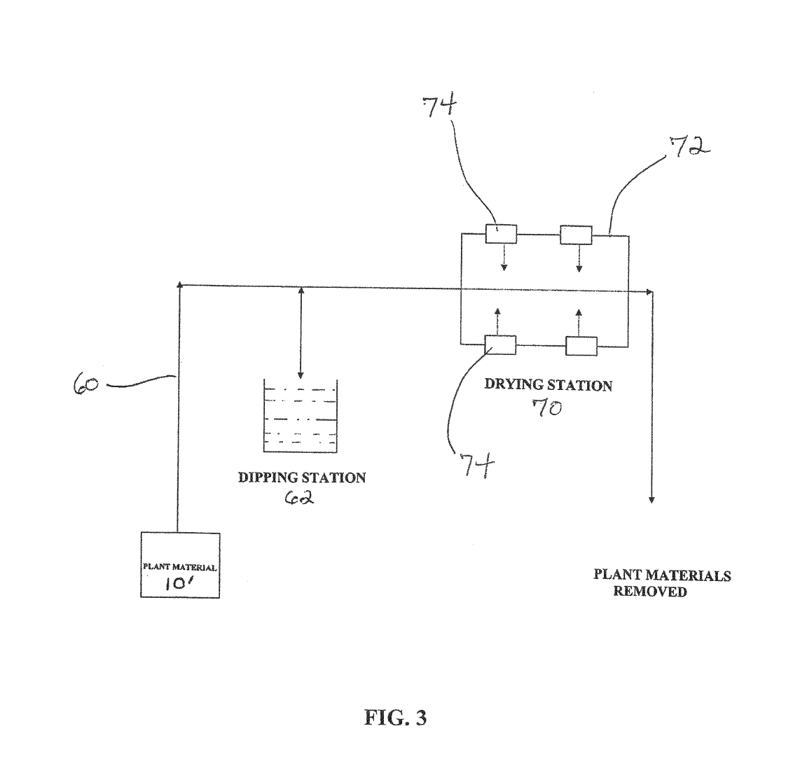

Referring now to FIG. 3, in another implementation, a desired non-living, dried plant material 10′ is selected, and then transferred, e.g., by a conveyer belt 60, to an application station, such as a dipping station 62. The substantially anhydrous material that includes the solvent, the binder soluble in and/or dispersible in the solvent and, optionally, the colorant is applied to the dried plant material to provide a coating on plant material. When a dipping station is utilized, typically, after the coated material is lifted out of the vat, it is held over the dipping station for 1-2 minutes to allow excess material to drop off the plant material before removal of the solvent. The solvent is then removed from the coating at a “drying station” 70, e.g., that includes a housing 72 that includes one or more blowers or fans 74, to provide a dried coating on the plant material. The finished plant materials that includes the decorative coating having a color, texture and/or gloss unusual to the dried plant material are removed from the coating apparatus.

In implementations in which the solvent is removed by passing air over the plant or plant material having the coating, the air can be, e.g., at a temperature of not more than about 50° C., such as not more than about 35° C., not more than about 30° C. or not more than about 25° C. Advantageously, lower temperatures are utilized so as to not damage the plant or plant material.

Rather than dipping, in some implementations, the applying is performed by spraying the plant or plant material with the substantially anhydrous material, allowing for a fully continuous process.

### EXAMPLES

The disclosure is further described in the following examples, which do not limit its scope.

Nylon resin NR1063, available from Top-Tex South, Inc., Charlotte, N.C., is a solution containing 30.0 (+/−2.0) weight percent Radilon S24E 100 (natural) in methanol. Radilon S24E 100, which is available from RadiciGroup Plastics, is a 2.4 RV nylon-6 based material. Radilon S24E 100 has the following properties.

### Radilon S24E 100, Natural Properties

| PROPERTY (Units) | VALUE/TEST METHOD |
|---|---|
| Tensile Modulus (MPa) | 2,500/ISO 527-2/1A (DAM* 1 mm/min.) |
| Yield Stress (MPa) | 70/ISO 527-2/1A (DAM, 50 mm/min.) |
| Nominal Strain at Break (Percent) | 70/ISO 527-2/1A (DAM, 50 mm/min.) |
| Flexural Modulus (MPa) | 2,200/ISO 178/1A (DAM, 2 mm/min.) |
| Flexural Strength (MPa) | 96/ISO 178/1A (DAM, 2 mm/min.) |
| Charpy Notched Impact Strength (KJ/m²) | 3/ISO 179eA (DAM) |
| Melting Temperature (° C.) | 220/ISO 11357-1-3 (scan rate 10° C./min.) |
| Deflection Temperature Under Load (° C.) | 60/ISO 75-2/Af (Max surface stress 1.8 MPa) |
| Vicat Softening Temperature (° C.) | 190/ISO 306/B50 (Load 50 N, heating |
| | rate 50° C./hour) |
| Density (kg/m³) | 1140/ISO 1183 |

*DAM means “dry, as molded”

Merlin brand name pigments were purchased from Engelhard, which included metallic and pearl pigments. The were used as received by dispersing with a shear mixer into the desired system. Other pigments were ground to less than 1 micron and dried to provide a dried toner. The dried toner pigments were dispersed with a shear mixer into the desired system.

Isobutanol was purchased from HCI, and used as received.

Paranol® VA 903 is a low glass transition temperature, self-crosslinking vinyl acrylic copolymer that crosslinks readily under ambient conditions and is provided as a solution/dispersion in water. The milky white liquid includes about 50 percent by weight solids, has viscosity of 100 cps (LVT #2 @ 60), pH of 4.5, bulk density of 8.7 pounds/gallon and surface tension of 40.5 dynes/cm. The material has a glass transition temperature of about −20° C. VA-903 is available from Para-Chem Southern, Inc. of Simpsonville, S.C. Paranol® VA 903 can be used as a secondary or overcoat material.

In Examples 1-3, the coating material was prepared by mixing the components of each Example in the order listed (top to bottom) with the aid of a shear mixer, e.g., available from Eppenbach or Hill.

### Example 1

### RTS Solvent Copper

| | Percent (By Weight) |
|---|---|
| Nylon Resin NR 1063 Solution | 75.00 |
| Isobutanol | 10.00 |
| Mearlin Super Copper 9350Z | 15.00 |
| Total | 100.00 |

### Example 2

### RTS Solvent Gold

| | Percent (By Weight) |
|---|---|
| Nylon Resin NR 1063 Solution | 75.00 |
| Isobutanol | 10.00 |
| Mearlin Super Bronze 9250Z | 1.00 |
| Mearlin Card Gold BN002 | 14.00 |
| Total | 100.00 |

### Example 3

### RTS Solvent Silver

| | Percent (By Weight) |
|---|---|
| Nylon Resin NR 1063 Solution | 75.00 |
| Isobutanol | 10.00 |
| Mearlin Card Silver BN001 | 15.00 |
| Total | 100.00 |

### Example 4

### Coating a Live, Potted Poinsettia

One of the desired RTS colors from above is selected and stirred or shaken prior to pouring into the liquids container of a spray gun. Any commercial sprayer that is driven by a 15-30 gallon air compressor, and that can deliver at least 6.3 SCFM of air at 40 PSI is suitable for applying the RTS colors. A commercial sprayer that is suitable is Pro Value Model #2308-PV, which is available from Advance Auto Parts.

The plant is sprayed to a desired coverage level. Glitter and/or artificial snow may then be applied within 2 minutes of spraying (if desired). If the glitter is not applied shortly after the color, a solution of glue, e.g., a 20 weight percent solution of Paranol® VA-903, can be applied, followed by the glitter and/or artificial snow.

### Other Implementations

A number of implementations have been described. Nevertheless, it will be understood that various modifications may be made without departing from the spirit and scope of the disclosure.

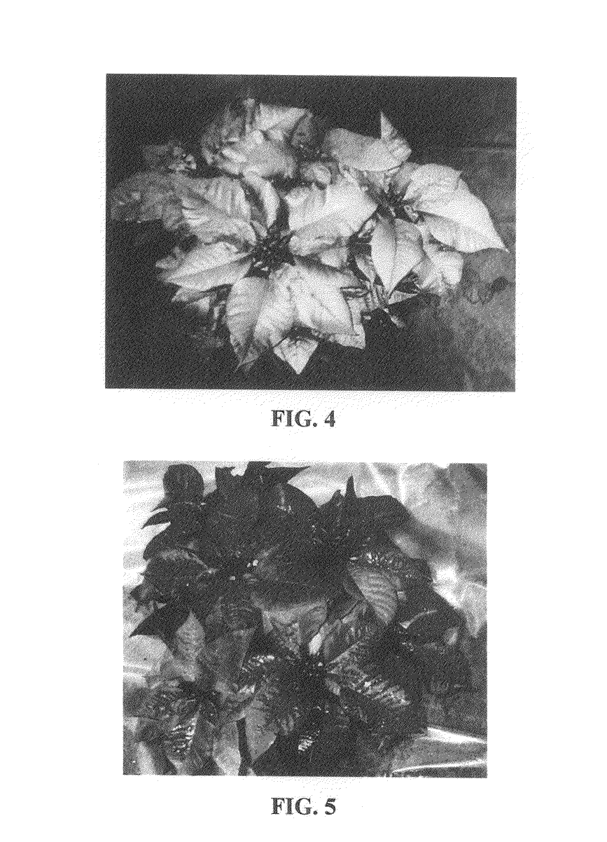

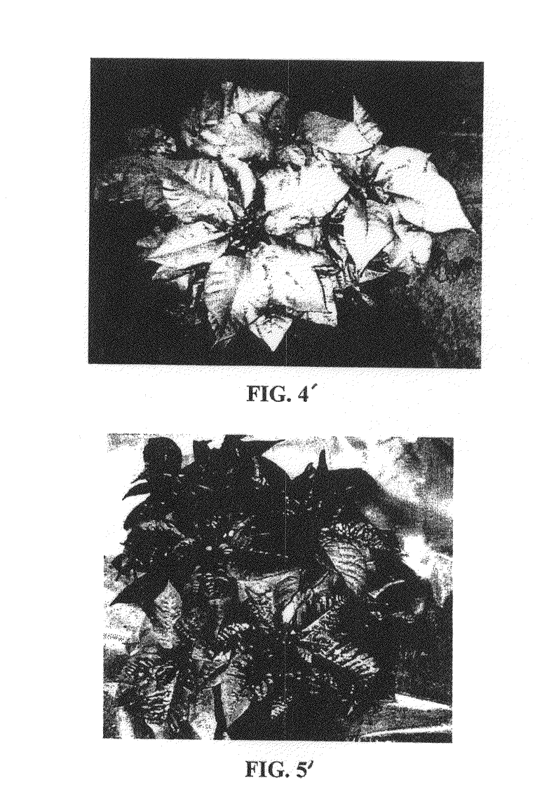

If desired, many different colors or combinations of colors can be used. For example, FIG. 4 shows a live poinsettia that is gold-colored, while FIG. 5 shows a live poinsettia that is lavender-colored. In FIG. 5, the coating utilized was RTS SOLVENT PURPLE, which is NR 1063 (75.00 weight percent), isobutanol (21.00 weight percent) and Acid Violet 48 crude (4.00 weight percent).

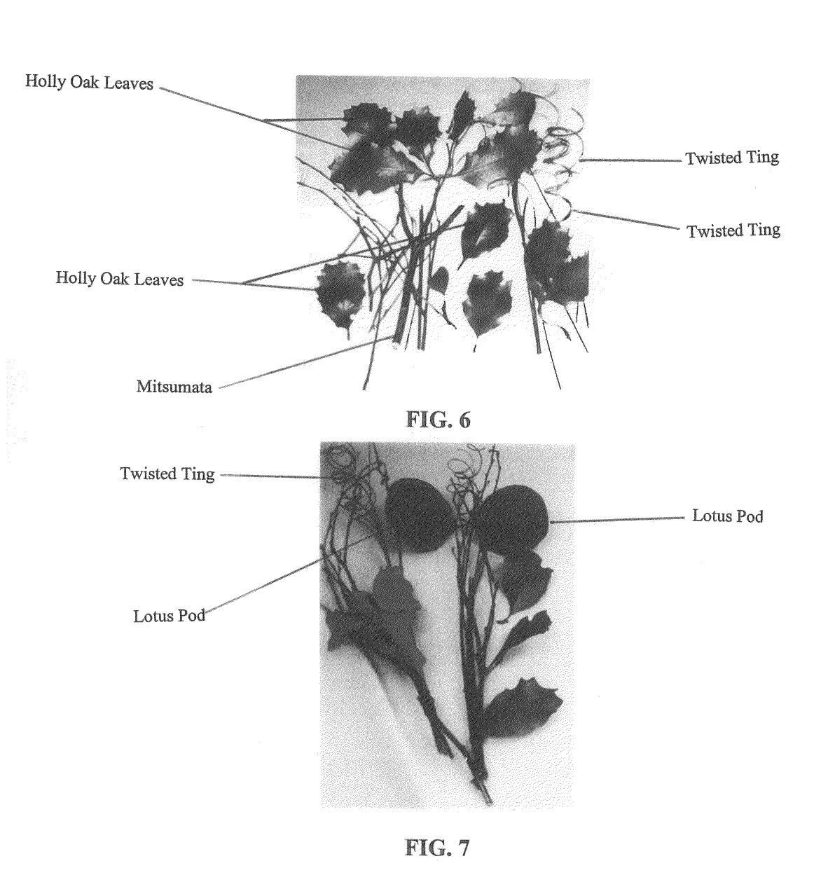

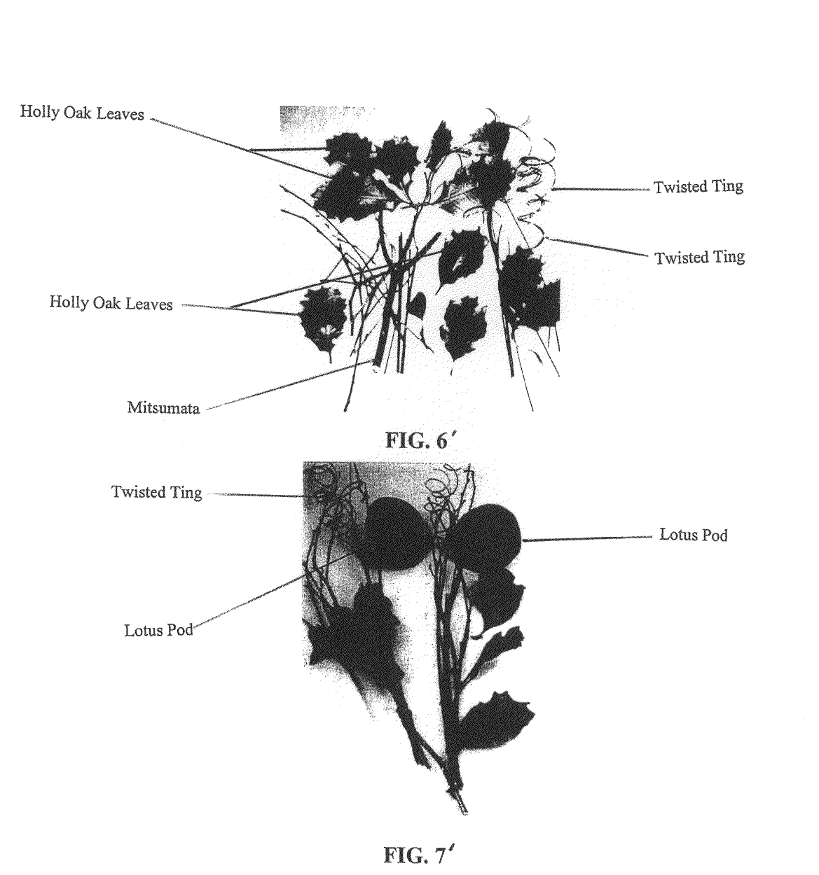

Many different colors or combinations of colors can be applied to non-living, dried plant materials, as shown in FIGS. 6 and 7. FIGS. 6 and 7 show that unnatural colors can be applied to Holly Oak leaves, Twisted Ting, Mitsumata and Lotus Pods (an many others). The coating applied to the materials of FIG. 6 is RTS SOLVENT COPPER of EXAMPLE 1. The coatings applied to the materials of FIG. 7 are (on the left) RTS SOLVENT RHODAMINE, which is NR 1063 (75.00 weight percent), isobutanol (19.00 weight percent) and Acid Red 52 crude (6.00 weight percent); and (on the right) RTS SOLVENT PEARL LILAC, which is NR 1063 (75.00 weight percent), isobutanol (10.00 weight percent), Merlin Megapearl 3100 (13.80 weight percent) and Pigment Violet 23 Dry Toner (1.20 weight percent).

Various effects can be applied to plants and plant materials. For example, glitter in the form of material pieces of various sizes and degrees of agglomeration can be applied to a glossy, non-colored coating while the glossy coating is still wet and/or tacky.

Artificial snow material in the form of material pieces of various sizes and degrees of agglomeration can be applied to the glossy coating while the glossy coating is still wet and/or tacky. This can provide a festive holiday feeling.

Still other implementations are within the scope of the following claims.

What is claimed is:

1. A method of decorating a plant or plant material, the method comprising:
providing a plant or plant material; and
applying a substantially anhydrous material comprising a solvent, a binder soluble in the solvent and, optionally, a colorant to the plant or plant material to provide a coating on the plant or plant material.

2. The method of claim 1, wherein a measured pH of a 10 weight percent mixture of 92 parts by weight of the anhydrous material and 8 parts by weight of POE (4) lauryl alcohol in water is between about 5.5 and about 8.5.

3. The method claim 1, wherein the colorant comprises a substantially insoluble pigment which is dispersible in the solvent, or a dye.

4. The method of claim 1, wherein the colorant comprises a substantially insoluble pigment which is dispersible in the solvent, and wherein the insoluble pigment comprises mica and/or titanium dioxide.

5. The method of claim 1, wherein the colorant comprises a substantially insoluble pigment which is dispersible in the solvent, and wherein the insoluble pigment comprises particles ground to a reduced size.

6. The method claim 1, wherein the colorant comprises a substantially insoluble pigment which is dispersible in the solvent, and wherein the insoluble pigment comprises particles having a maximum dimension of less than 5 μm.

7. The method of claim 1, wherein the solvent comprises alcohol.

8. The method of claim 7, wherein the alcohol is selected from the group consisting of methanol, ethanol, n-propanol, isopropanol, n-butanol, isobutanol (2-methyl-1-propanol), and mixtures thereof.

9. The method of claim 7, wherein the alcohol comprises methanol and/or isobutanol.

10. The method of claim 1, wherein the solvent comprises ether.

11. The method of claim 10, wherein the ether comprises ethyl ether and/or tetrahydrofuran.

12. The method of claim 1, wherein the solvent comprises hydrocarbon.

13. The method of claim 12, wherein the hydrocarbon comprises heptane and/or toluene.

14. The method of claim 1, wherein the solvent comprises ketone.

15. The method of claim 14, wherein the ketone comprises acetone and/or methyl ethyl ketone.

16. The method of claim 1, wherein the solvent comprises ester.

17. The method of claim 16, wherein the ester comprises ethyl acetate.

18. The method of claim 1, wherein the solvent has a boiling point at 1 atm pressure of less than about 175° C.

19. The method of claim 1, wherein the solvent has a vapor pressure of greater than about 7.5 mm Hg at 25° C.

20. The method of claim 1, wherein the binder comprises a polyamide and/or a polyamide copolymer.

21. The method of claim 20, wherein the polyamide comprises a Nylon-6 and/or a Nylon 6-based copolymer.

22. The method of claim 20, wherein the polyamide has a relative viscosity (RV), as measured using ASTM D2857-95 in methanol, of less than about 50.0.

23. The method of claim 1, wherein the binder has a number average molecular weight relative to narrow disperse polyethylene glycol standards in tetrahydrofuran of less than about 25,000.

24. The method of claim 1, wherein the binder is present in the substantially anhydrous material from about 2.5 percent to about 30.0 percent by weight.

25. The method of claim 1, wherein the colorant is present in the substantially anhydrous material from about 2.5 percent to about 25 percent by weight.

26. The method of claim 1, wherein the solvent is present in the substantially anhydrous material from about 60.0 percent to about 95.0 percent by weight.

27. The method of claim 1, wherein the substantially anhydrous material has less than about 1 percent by weight water, as measured by Karl Fischer titration using ASTM E203-01.

28. The method of claim 1, wherein the substantially anhydrous material further comprises an anti-wicking material.

29. The method of claim 1, wherein the substantially anhydrous material further comprises a emulsifier.

30. The method of claim 29, wherein the emulsifier comprises a non-ionic emulsifier, ionic emulsifier or a mixture of a non-ionic and ionic emulsifier.

31. The method of claim 1, wherein the substantially anhydrous material further comprises a biocidal material.

32. The method of claim 1, wherein the provided plant or plant material is a live plant, such as a potted plant or a tree.

33. The method of claim 32, wherein the live plant is selected from the group consisting of aloe, azalea, amaryllis, American ivy, bird-of-paradise, buttercup, cactus, day lily, Easter lily, hyacinth, hydrangea, ivy, jasmine, morning glory, oleander, poinsettia, and Virginia creeper.

34. The method of claim 1, wherein the provided plant or plant material is a non-living, dried plant material.

35. The method of claim 34, wherein the non-living, dried plant material is selected from the group consisting of mosses, eucalyptus, cattails, bearded wheat, oak leaves, lotus pods, willow branches, palms, twisted ting ting, birch twigs, bamboo, pine cones, holly, sisal, wreathes, ferns, dried roses, and mixtures thereof.

36. A method of decorating a plant or a plant material, the method comprising:
providing a plant or plant material;
transferring the plant or plant material to an application station;
applying a substantially anhydrous material comprising a solvent, a binder soluble in the solvent and, optionally, a colorant to the plant or plant material to provide a coating on the plant or plant material; and
removing the solvent from the coating to provide a dried coating on the plant or plant material.

37. The method of claim 36, wherein the solvent is removed by passing air over the plant or plant material having the coating.

38. The method of claim 37, wherein the air is at a temperature of not more than about 50° C.

39. The method of claim 36, wherein the applying is performed by dipping the plant or plant material in a vessel containing the substantially anhydrous material.

40. The method of claim 36, wherein the applying is performed by spraying the plant or plant material with the substantially anhydrous material.

41. A decorated plant or plant material comprising:
a flower, leaf and/or branch; and
a decorative coating extending from a portion of the flower, leaf and/or branch,
wherein the decorative coating is applied as a substantially anhydrous material comprising a solvent, a binder soluble in the solvent and, optionally, a colorant.

42. The method of claim 41, wherein a measured pH of a 10 weight percent mixture of 92 parts by weight of the anhydrous material and 8 parts by weight of POE (4) lauryl alcohol in water is between about 5.5 and about 8.5.

43. A decorated plant or plant material comprising a flower, leaf and/or branch, and a decorative coating having a color, texture and/or gloss unusual to the native plant or plant material extending from a portion of the flower, leaf and/or branch, wherein the coating is applied as a substantially anhydrous material.

44. The decorated plant or plant material of claim 43, wherein the substantially anhydrous material comprises a solvent, a binder soluble in the solvent and, optionally, a colorant.
